(19) United States
(12) Patent Application Publication
(10) Pub. No.: US 2026/0204285 A1
(43) Pub. Date: Jul. 16, 2026

(54) MAGNETIC DISK DEVICE HAVING MOTOR

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Kenji HAYASAKA, Shinagawa Tokyo (JP)

(21) Appl. No.: 19/187,549

(22) Filed: Apr. 23, 2025

(30) Foreign Application Priority Data
Jan. 10, 2025 (JP) 2025-003820

(51) Int. Cl. G11B 19/20

(52) U.S. Cl. CPC G11B 19/2045

(57) ABSTRACT

According to one embodiment, a magnetic disk includes a housing, a motor, magnetic disks, and spacers. The motor includes a hub rotatable around a rotation axis and a clamp attached to the hub. The magnetic disks and spacers are attached to the motor while aligned with each other along the rotation axis. The hub has a support wall supporting the magnetic disks and spacers, and a first outer circumferential surface extending from the support wall in an extension direction along the rotation axis to support at least one of the magnetic disks and at least one of the spacers. The clamp has a second outer circumferential surface supporting at least one of the spacers, and a retaining wall protruding from the second outer circumferential surface. The clamp holds the magnetic disks and spacers in-between the support wall and the retaining wall.

### CROSS-REFERENCE TO RELATED APPLICATIONS

This application is based upon and claims the benefit of priority from Japanese Patent Application No. 2025-003820, filed on Jan. 10, 2025; the entire contents of which are incorporated herein by reference.

### FIELD

Embodiments described herein relate generally to a magnetic disk device.

### BACKGROUND

Magnetic disk devices such as a hard disk drive (HDD) generally include a plurality of magnetic disks and a motor that rotates the plurality of magnetic disks. Such a motor includes a hub that fits into the holes in the plurality of magnetic disks, and a clamp attached to the hub to hold the plurality of magnetic disks.

In some cases the clamp may have lower rigidity. Such a clamp may cause the magnetic disks in rotation to undulate.

### BRIEF DESCRIPTION OF THE DRAWINGS

FIG. 1 is an exemplary perspective view illustrating an exploded HDD according to a first embodiment;

FIG. 2 is an exemplary cross-sectional view illustrating a part of the HDD according to the first embodiment;

FIG. 3 is an exemplary cross-sectional view illustrating a portion in the vicinity of a clamp of the HDD according to the first embodiment;

FIG. 4 is an exemplary cross-sectional view illustrating a portion in the vicinity of a clamp of an HDD according to a second embodiment;

FIG. 5 is an exemplary cross-sectional view illustrating a portion in the vicinity of a clamp of an HDD according to a third embodiment; and

FIG. 6 is an exemplary cross-sectional view illustrating a portion in the vicinity of a clamp of an HDD according to a fourth embodiment.

### DETAILED DESCRIPTION

According to one embodiment, a magnetic disk includes a housing, a motor, a plurality of magnetic disks, and a plurality of spacers. The motor includes a hub being attached to the housing inside the housing so as to be rotatable around a rotation axis relative to the housing, and a clamp being attached to the hub. The plurality of magnetic disks are attached to the motor while aligned with each other along the rotation axis. The plurality of spacers are attached to the motor, each of which is located between two adjacent magnetic disks among the plurality of magnetic disks or between the clamp and one of the plurality of magnetic disks. Each of the plurality of magnetic disks has a first inner circumferential surface oriented toward the rotation axis. Each of the plurality of spacers has a second inner circumferential surface oriented toward the rotation axis. The hub has a support wall supporting the plurality of magnetic disks and the plurality of spacers, and a first outer circumferential surface extending from the support wall in an extension direction along the rotation axis to support the first inner circumferential surface of at least one of the plurality of magnetic disks and the second inner circumferential surface of at least one of the plurality of spacers. The clamp has a second outer circumferential surface supporting the second inner circumferential surface of at least one of the plurality of spacers, and a retaining wall protruding from the second outer circumferential surface. The clamp holds the plurality of magnetic disks and the plurality of spacers in-between the support wall and the retaining wall.

### First Embodiment

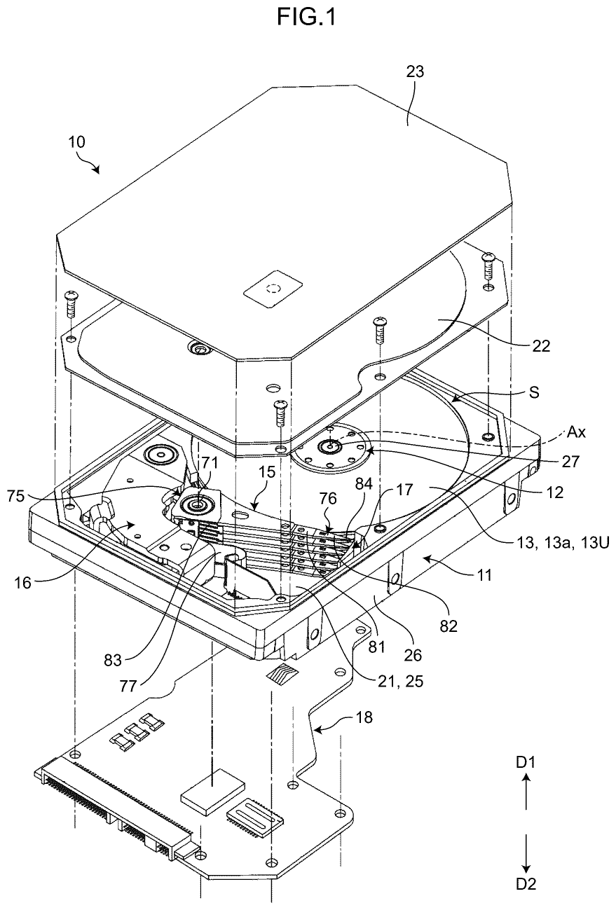

Hereinafter, a first embodiment will be described with reference to FIGS. 1 to 3. It is noted that, in the present specification, components according to embodiments and descriptions of the components may be described in a plurality of expressions. The components and the description thereof are examples, and are not limited by the expression of the present specification. Components may also be identified with names different from those described in the present specification. In addition, the components may be described by expressions different from the expressions in the present specification.

In the following description, “suppress” is defined as, for example, preventing occurrence of an event, an action, or an influence, or reducing a degree of the event, the action, or the influence. Furthermore, in the following description, “restrict” is defined as, for example, preventing movement or rotation, or allowing movement or rotation within a predetermined range and preventing movement or rotation beyond the predetermined range.

FIG. 1 is an exemplary perspective view illustrating a hard disk drive (HDD) 10 according to the first embodiment in an exploded manner. The HDD 10 is an example of a magnetic disk device and may also be referred to as an electronic device, a storage device, an external storage device, or a disk device.

As illustrated in the drawings, in the present specification, a first direction D1 and a second direction D2 are defined for convenience. The first direction D1 is an example of an extension direction. The first direction D1 is a direction along the thickness of the HDD 10. The second direction D2 is a direction opposite the first direction D1.

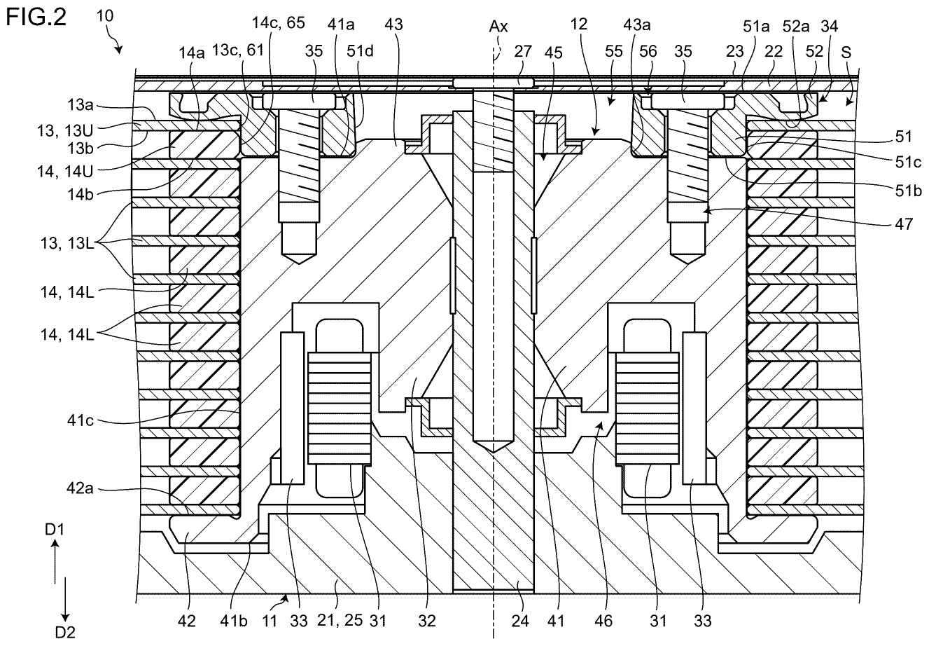

FIG. 2 is an exemplary cross-sectional view illustrating a part of the HDD 10 according to the first embodiment. The HDD 10 includes a housing 11, a spindle motor 12, a plurality of magnetic disks 13, and a plurality of spacers 14 that are illustrated in FIG. 2, and a head stack assembly (HSA) 15, a voice coil motor (VCM) 16, a ramp load mechanism 17, and a printed circuit board (PCB) 18 that are illustrated in FIG. 1. The spindle motor 12 is an example of a motor.

As illustrated in FIG. 2, the housing 11 includes a base 21, an inner cover 22, an outer cover 23, and a shaft 24. As illustrated in FIG. 1, the base 21 has a substantially rectangular parallelepiped box shape that is open in the first direction D1. The housing 11 houses the spindle motor 12, the magnetic disks 13, the spacers 14, the HSA 15, the VCM 16, and the ramp load mechanism 17 in an internal space S of the base 21.

The base 21 has a bottom wall 25 and a side wall 26. The bottom wall 25 has a substantially rectangular (quadrangular) plate shape arranged so as to be substantially orthogonal to the first direction D1 and the second direction D2. The side wall 26 protrudes in the first direction D1 from the edge of the bottom wall 25 and has a substantially rectangular frame shape.

The inner cover 22 is attached to the end of the side wall 26 in the first direction D1 with, for example, a screw, and closes the space S inside the base 21. The outer cover 23 covers the inner cover 22 and is attached, for example by welding, to the end of the side wall 26 in the first direction D1.

After components are attached to the inside of the base 21 and the inner cover 22 and outer cover 23 are attached to the base 21, the air inside the housing 11 is evacuated through air vents provided respectively in the inner cover 22 and the outer cover 23. Furthermore, the inside of the housing 11 is filled with gas different from air.

The gas filling the inside of the housing 11 is, for example, a low-density gas having a density lower than that of air, or an inert gas having low reactivity. For example, the inside of the housing 11 is filled with helium. It is noted that the inside of the housing 11 may be filled with another fluid. The air vent of the outer cover 23 is closed by a seal. Consequently, the space S is sealed airtightly.

As illustrated in FIG. 2, the shaft 24 protrudes from the bottom wall 25 in the first direction D1. The shaft 24 has a substantially cylindrical shape extending along a rotation axis Ax. The rotation axis Ax is, for example, the axis of the shaft 24, and extends in the first direction D1 and the second direction D2. That is, each of the first direction D1 and the second direction D2 is a direction along the rotation axis Ax. It is noted that the axis of the shaft 24 may be shifted from the rotation axis Ax.

Hereinafter, a radial direction and a circumferential direction are defined for convenience. The radial direction is a direction orthogonal to the rotation axis Ax. The radial direction includes a plurality of directions orthogonal to the rotation axis Ax. The circumferential direction is a direction around the rotation axis Ax. The circumferential direction includes a clockwise direction and a counterclockwise direction around the rotation axis Ax.

The end of the shaft 24 in the second direction D2 is fixed to the bottom wall 25. The end of the shaft 24 in the first direction D1 is attached to the inner cover 22 by, for example, a screw 27. It is noted that the shaft 24 is not limited to this example.

The spindle motor 12 includes, for example, a plurality of coils 31, a hub 32, a plurality of magnets 33, a clamp 34, and a plurality of screws 35. It is noted that the spindle motor 12 is not limited to this example.

The plurality of coils 31 are arranged with an approximately equal interval therebetween in the circumferential direction around the shaft 24. The plurality of coils 31 are held, for example, by the base 21, and are electrically connected, for example, to the PCB 18 located outside the housing 11.

The hub 32 is attached to the shaft 24 of the housing 11 so as to be rotatable around the rotation axis Ax relative to the housing 11. The hub 32 includes a hub tube 41, a support wall 42, and a protrusion 43.

The hub tube 41 has a substantially cylindrical shape extending along the rotation axis Ax. The hub tube 41 has two end surfaces 41a and 41b and an outer circumferential surface 41c. The outer circumferential surface 41c is an example of a first outer circumferential surface.

The end surface 41a is an end surface of the hub tube 41 in the first direction D1 and is oriented in the first direction D1 as a whole. The end surface 41b is opposite the end surface 41a. That is, the end surface 41b is an end surface of the hub tube 41 in the second direction D2 and is oriented in the second direction D2 as a whole. The outer circumferential surface 41c is a substantially cylindrical curved surface extending along the rotation axis Ax. The outer circumferential surface 41c is oriented outwards in the radial direction. The diameter of the outer circumferential surface 41c is, for example, approximately 25.0 mm. It is noted that the diameter of the outer circumferential surface 41c is not limited to this example.

The hub tube 41 is provided with a central hole 45, a groove 46, and a plurality of threaded holes 47. The central hole 45 penetrates the hub tube 41 along the rotation axis Ax and is open in the two end surfaces 41a and 41b. The shaft 24 extends through the central hole 45. As a result, the hub tube 41 of the hub 32 is attached to the shaft 24 so as to be rotatable around the rotation axis Ax. For example, a fluid dynamic bearing is provided between the shaft 24 and the hub tube 41.

The groove 46 is open in the end surface 41b of the hub tube 41 and extends in the circumferential direction. Each of the plurality of coils 31 is at least partially arranged inside the groove 46. Further, each of the plurality of magnets 33 is arranged inside the groove 46 and is attached to the hub tube 41. The plurality of magnets 33 are arranged with an approximately equal interval therebetween in the circumferential direction.

A plurality of threaded holes 47 are open in the end surface 41a of the hub tube 41 and are arranged with an equal interval therebetween in the circumferential direction. The number of the plurality of threaded holes 47 is equal to or larger than the number of the plurality of screws 35. Each of the plurality of threaded holes 47 has a female thread inside.

The support wall 42 protrudes radially outwards from the end of the outer circumferential surface 41c of the hub tube 41 in the second direction D2. Accordingly, the outer circumferential surface 41c extends from the support wall 42 in the first direction D1. The support wall 42 has a substantially annular shape extending in the circumferential direction. The support wall 42 has a support surface 42a. The support surface 42a is substantially flat and is oriented in the first direction D1.

The protrusion 43 protrudes from the end surface 41a of the hub tube 41. In the radial direction, the protrusion 43 is located between the central hole 45 and the threaded hole 47. The protrusion 43 may have an annular shape extending in the circumferential direction, or a plurality of protrusions may be arranged in the circumferential direction.

The protrusion 43 has a fitting surface 43a. The fitting surface 43a is an example of a third outer circumferential surface. The fitting surface 43a is, for example, a radially outer end surface of the protrusion 43, and is oriented outwards in the radial direction. In the case of the protrusion 43 of an annular shape, the protrusion 43 has a fitting surface 43a of a substantially cylindrical shape extending along the rotation axis Ax. It is noted that the fitting surface 43a is not limited to this example, but may be oriented, for example, in the oblique direction. The diameter of the fitting surface 43a is, for example, about 13.6 mm. It is noted that the diameter of the fitting surface 43a is not limited to this example.

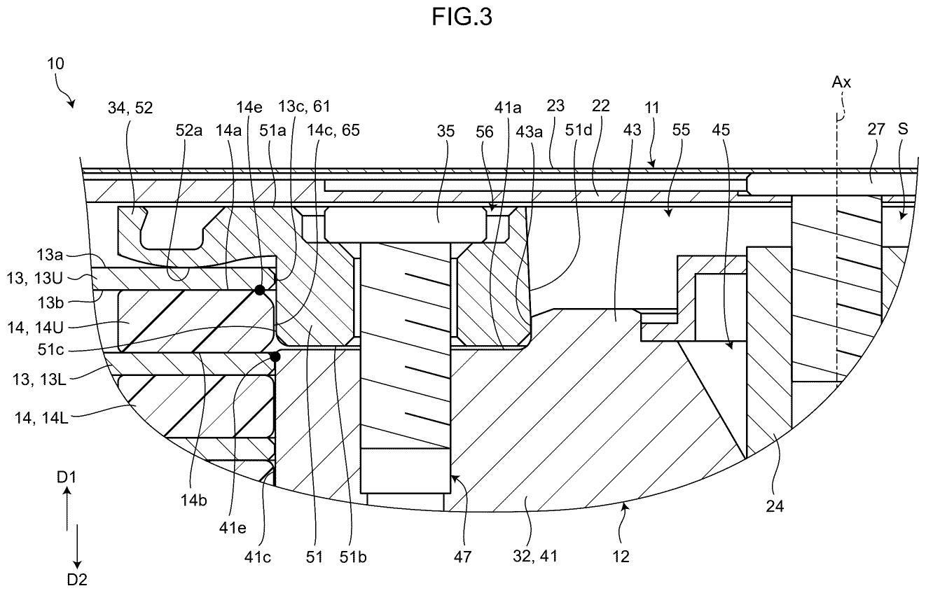

FIG. 3 is an exemplary cross-sectional view illustrating a portion in the vicinity of the clamp 34 of the HDD 10 according to the first embodiment. As illustrated in FIG. 3, the clamp 34 is attached to the hub 32. The clamp 34 includes a clamp tube 51 and a retaining wall 52.

The clamp tube 51 has a substantially cylindrical shape extending along the rotation axis Ax. The clamp tube 51 has two end surfaces 51a and 51b, an outer circumferential surface 51c, and an inner circumferential surface 51d. The outer circumferential surface 51c is an example of a second outer circumferential surface. The inner circumferential surface 51d is an example of a third inner circumferential surface.

The end surface 51a is an end surface of the clamp tube 51 in the first direction D1 and is oriented in the first direction D1 as a whole. The end surface 51b is opposite the end surface 51a. That is, the end surface 51b is an end surface of the clamp tube 51 in the second direction D2 and is oriented in the second direction D2 as a whole.

A distance (thickness of the clamp 34) between the end surface 51a and the end surface 51b in a direction along the rotation axis Ax is, for example, about 2.3 mm. It is noted that the thickness of the clamp 34 is not limited to this example.

The outer circumferential surface 51c is a substantially cylindrical curved surface extending along the rotation axis Ax. The outer circumferential surface 51c is oriented outwards in the radial direction. The diameter of the outer circumferential surface 51c is substantially equal to the diameter of the outer circumferential surface 41c of the hub tube 41. It is noted that the diameter of the outer circumferential surface 51c may be smaller or larger than the diameter of the outer circumferential surface 41c of the hub tube 41.

The inner circumferential surface 51d is opposite the outer circumferential surface 51c. The inner circumferential surface 51d is oriented inwards in the radial direction. That is, the inner circumferential surface 51d is oriented toward the rotation axis Ax. It is noted that the inner circumferential surface 51d may be oriented, for example, in an oblique direction.

The diameter of the inner circumferential surface 51 d is, for example, about 13.6 mm. That is, the diameter of the inner circumferential surface 51d is slightly larger than the diameter of the fitting surface 43a of the protrusion 43 of the hub 32. It is noted that the diameter of the inner circumferential surface 51d is not limited to the above-described example.

The clamp tube 51 is provided with a hole 55 and a plurality of insertion holes 56. The hole 55 is defined by the inner circumferential surface 51d and penetrates the clamp tube 51 along the rotation axis Ax. Therefore, the hole 55 is open in the two end surfaces 51a and 51b. The plurality of insertion holes 56 are arranged with an approximately equal interval therebetween in the circumferential direction. Each of the plurality of insertion holes 56 penetrates the clamp tube 51 and is open in the two end surfaces 51a and 51b.

The protrusion 43 of the hub 32 is fitted into the hole 55. The fitting surface 43a of the protrusion 43 is at least partially in contact with the inner circumferential surface 51d of the clamp tube 51. As a result, the fitting surface 43a supports the inner circumferential surface 51d and restricts the radial movement of the clamp 34 relative to the hub 32.

The number of the plurality of insertion holes 56 is equal to or larger than the number of the plurality of threaded holes 47 of the hub 32. Each of the plurality of insertion holes 56 communicates with a corresponding one of the plurality of threaded holes 47. The screw 35 is fitted into the threaded hole 47 through the insertion hole 56. As a result, the plurality of screws 35 attach the clamp tube 51 of the clamp 34 to the hub tube 41 of the hub 32.

The retaining wall 52 protrudes radially outwards from the end of the outer circumferential surface 51c of the clamp tube 51 in the first direction D1. Accordingly, the outer circumferential surface 51c extends from the retaining wall 52 in the second direction D2. The retaining wall 52 has a substantially annular shape extending in the circumferential direction.

The retaining wall 52 has an abutting surface 52a. The abutting surface 52a is oriented in the second direction D2 as a whole. As illustrated in FIG. 2, the support surface 42a of the support wall 42 and the abutting surface 52a of the retaining wall 52 face each other with a space therebetween.

The plurality of magnetic disks 13 are arranged so as to be substantially orthogonal to the rotation axis Ax. As illustrated in FIG. 3, each of the plurality of magnetic disks 13 has two flat surfaces 13a and 13b and an inner circumferential surface 13c. The inner circumferential surface 13c is an example of a first inner circumferential surface.

The flat surface 13a is an end surface of the magnetic disk 13 in the first direction D1 and is oriented in the first direction D1 as a whole. The flat surface 13b is opposite the flat surface 13a. That is, the flat surface 13b is the end surface of the magnetic disk 13 in the second direction D2 and is oriented in the second direction D2 as a whole. A magnetic recording layer is provided on at least one of the two flat surfaces 13a and 13b.

The inner circumferential surface 13c is oriented inwards in the radial direction as a whole. That is, the inner circumferential surface 13c is oriented toward the rotation axis Ax. In the example in FIG. 3, the inner circumferential surface 13c has a tapered surface recessed from the flat surface 13b so as to taper in the first direction D1, a tapered surface recessed from the flat surface 13a so as to taper in the second direction D2, and a substantially cylindrical curved surface extending along the rotation axis Ax between the two tapered surfaces. It is noted that the inner circumferential surface 13c is not limited to the example of FIG. 3. The minimum diameter of the inner circumferential surface 13c is, for example, about 25.0 mm. It is noted that the diameter of the inner circumferential surface 13c is not limited to this example.

Each magnetic disk 13 is provided with a disk hole 61. The disk hole 61 is defined by the inner circumferential surface 13c and penetrates the magnetic disk 13 along the rotation axis Ax. As a result, the disk hole 61 opens in the two flat surfaces 13a and 13b.

Each of the plurality of spacers 14 has a substantially annular shape extending in the circumferential direction and is arranged to be substantially orthogonal to the rotation axis Ax. Each of the plurality of spacers 14 has two flat surfaces 14a and 14b and an inner circumferential surface 14c. The inner circumferential surface 14c is an example of a second inner circumferential surface.

The flat surface 14a is an end surface of the spacer 14 in the first direction D1 and is oriented in the first direction D1 as a whole. The flat surface 14b is opposite the flat surface 14a. That is, the flat surface 14b is an end surface of the spacer 14 in the second direction D2 and is oriented in the second direction D2 as a whole.

The inner circumferential surface 14c is oriented inwards in the radial direction as a whole. That is, the inner circumferential surface 14c is oriented toward the rotation axis Ax. In the example of FIG. 3, the inner circumferential surface 14c includes a tapered surface recessed from the flat surface 14b so as to taper in the first direction D1, a tapered surface recessed from the flat surface 14a so as to taper in the second direction D2, and a substantially cylindrical curved surface extending along the rotation axis Ax between the two tapered surfaces. The minimum diameter of the inner circumferential surface 14 c is, for example, about 25.1 mm. It is noted that the inner circumferential surface 14c is not limited to the example of FIG. 3 and is not limited to the above diameter.

Each spacer 14 is provided with a spacer hole 65. The spacer hole 65 is defined by the inner circumferential surface 14c and penetrates the spacer 14 along the rotation axis Ax. As a result, the spacer hole 65 opens in the two flat surfaces 14a and 14b.

The plurality of magnetic disks 13 are arranged along the rotation axis Ax. The plurality of spacers 14 are alternately arranged with the plurality of magnetic disks 13 along the rotation axis Ax. That is, the plurality of magnetic disks 13 and the plurality of spacers 14 are alternately stacked along the rotation axis Ax. It is noted that two or more of the plurality of spacers 14 may be arranged between two adjacent disks 13 among the plurality of magnetic disks 13.

In the first embodiment, each of the plurality of spacers 14 is arranged between two adjacent magnetic disks 13 to maintain a distance between the two adjacent magnetic disks 13. The flat surface 14a of each spacer 14 contacts the flat surface 13b of one magnetic disk 13 adjacent (for example, the upper side in FIG. 2) to the spacer 14. The flat surface 14b of each spacer 14 contacts the flat surface 13a of another magnetic disk 13 adjacent (for example, the lower side in FIG. 2) to the spacer 14.

As illustrated in FIG. 2, the plurality of magnetic disks 13 and the plurality of spacers 14 are arranged between the support wall 42 of the hub 32 and the retaining wall 52 of the clamp 34. The plurality of magnetic disks 13 and the plurality of spacers 14 are attached to the spindle motor 12.

The support surface 42a of the support wall 42 supports the stacked magnetic disks 13 and spacers 14. The retaining wall 52 presses the stacked magnetic disks 13 and spacers 14 toward the support wall 42 by, for example, elastic force. As a result, the clamp 34 holds the plurality of magnetic disks 13 and the plurality of spacers 14 in-between the support wall 42 and the retaining wall 52.

The plurality of magnetic disks 13 includes an uppermost magnetic disk 13U and a plurality of lower magnetic disks 13L. It is noted that the upper and lower descriptions in the present embodiment are names for convenience based on the arrangement of FIG. 2, and do not limit the orientation, position, and usage mode.

The uppermost magnetic disk 13U is a magnetic disk 13 closest to the retaining wall 52 among the plurality of magnetic disks 13. The plurality of lower magnetic disks 13L are the rest of the plurality of magnetic disks 13.

The plurality of spacers 14 include an uppermost spacer 14U and a plurality of lower spacers 14L. The uppermost spacer 14U is a spacer 14 closest to the retaining wall 52 among the plurality of spacers 14. The plurality of lower spacers 14L are the rest of the plurality of spacers 14.

In the first embodiment, the hub tube 41 of the hub 32 is fitted into the disk holes 61 of the plurality of lower magnetic disks 13L and the spacer holes 65 of the plurality of lower spacers 14L. As a result, the outer circumferential surface 41c of the hub tube 41 contacts the inner circumferential surface 13c of the lower magnetic disk 13L and the inner circumferential surface 14c of the lower spacer 14L.

The outer circumferential surface 41c supports the inner circumferential surface 13c of the lower magnetic disk 13L, and restricts the radial movement of the lower magnetic disk 13L relative to the hub 32. Further, the outer circumferential surface 41c supports the inner circumferential surface 14c of the lower spacer 14L and restricts the radial movement of the lower spacer 14L relative to the hub 32.

Meanwhile, the clamp tube 51 of the clamp 34 is fitted into the disk hole 61 of the uppermost magnetic disk 13U and the spacer hole 65 of the uppermost spacer 14U. As a result, the outer circumferential surface 51c of the clamp tube 51 is in contact with the inner circumferential surface 13c of the uppermost magnetic disk 13U and the inner circumferential surface 14c of the uppermost spacer 14U.

The outer circumferential surface 51c supports the inner circumferential surface 13c of the uppermost magnetic disk 13U, and restricts the radial movement of the uppermost magnetic disk 13U relative to the clamp 34.

Further, the outer circumferential surface 41c supports the inner circumferential surface 14c of the uppermost spacer 14U and restricts the radial movement of the uppermost spacer 14U relative to the clamp 34.

In the first embodiment, the uppermost magnetic disk 13U is located between the uppermost spacer 14U and the retaining wall 52. Therefore, the abutting surface 52a of the retaining wall 52 comes into contact with the flat surface 13a of the uppermost magnetic disk 13U.

As illustrated in FIG. 3, the outer circumferential surface 41c of the hub tube 41 has an upper end 41e. The upper end 41e is an end of the outer circumferential surface 41c in the first direction D1. The inner circumferential surface 14c of the spacer 14 also has the upper end 14e. The upper end 14e is an end of the inner circumferential surface 14c in the first direction D1.

The upper end 41e of the outer circumferential surface 41c is located closer to the support wall 42 than the entire uppermost magnetic disk 13U. Further, the upper end 41e of the outer circumferential surface 41c is located closer to the support wall 42 than the entire uppermost spacer 14U. Thus, the upper end 41e of the outer circumferential surface 41c is located closer to the support wall 42 than the upper end 14e of the inner circumferential surface 14c.

The end surface 41a of the hub tube 41 is located closer to the support wall 42 than the entire uppermost magnetic disk 13U. Further, the end surface 41a of the hub tube 41 is located closer to the support wall 42 than the upper end 14e of the inner circumferential surface 14c.

The HSA 15 illustrated in FIG. 1 is attached to a shaft 71. The shaft 71 is provided at a position separated from the magnetic disk 13 in the radial direction. The shaft 71 protrudes from the bottom wall 25 of the housing 11 in the first direction D1. The HSA 15 may be rotated around the shaft 71.

The HSA 15 has a carriage 75, a plurality of head gimbal assemblies (HGAs) 76, and a flexible printed circuit board (FPC) 77.

The carriage 75 is rotatably supported by the shaft 71 with a bearing interposed therebetween. The plurality of HGAs 76 and a voice coil of the VCM 16 are attached to the carriage 75. The VCM 16 includes the voice coil, a pair of yokes, and a magnet provided on the yoke.

Each of the plurality of HGAs 76 includes a base plate 81, a load beam 82, a flexure 83, and a slider 84. The slider 84 may also be referred to as a head slider or a magnetic head.

The base plate 81 is attached to an arm of the carriage 75. The load beam 82 has a plate shape thinner than the base plate 81 and extends from the base plate 81. The flexure 83 is a kind of flexible printed wiring board formed in an elongated belt shape.

The slider 84 is arranged at a distal end of the HGA 76 and is mounted on the flexure 83. The slider 84 records and reproduces information on and from a magnetic recording layer of the flat surface 13a or the flat surface 13b of the magnetic disk 13. In other words, the slider 84 reads and writes information from and to the magnetic disk 13.

One end of the FPC 77 is attached to the carriage 75. The FPC 77 is electrically connected to the slider 84 through the flexure 83. The other end of the FPC 77 is attached to the bottom wall 25 of the base 21.

The VCM 16 rotates the carriage 75 around the shaft 71. As a result, the VCM 16 can arrange the slider 84 at a desired position on the flat surface 13a or the flat surface 13b of the magnetic disk 13. In addition, the VCM 16 can unload the slider 84 such that the HGA 76 is supported by the ramp load mechanism 17.

The PCB 18 is, for example, a rigid board such as a glass epoxy board, and is a multilayer board, a build-up board, or the like. The PCB 18 is arranged outside the housing 11 and is attached to the bottom wall 25 of the base 21.

Various electronic components such as a relay connector connected to the FPC 77, an interface (I/F) connector connected to a host computer, and a controller that controls the operation of the HDD 10 are mounted on the PCB 18. The relay connector is electrically connected to the FPC 77 via, for example, a connector provided on the bottom wall 25.

The PCB 18 is electrically connected to the slider 84 through the FPC 77 and the flexure 83. A controller on the PCB 18 controls the slider 84 to read and write information from and to the magnetic disk 13. Further, the PCB 18 is electrically connected to the coil 31 of the spindle motor 12 so as to control the spindle motor 12.

When the PCB 18 inputs an electric signal to the coil 31, the spindle motor 12 rotates the hub 32 around the rotation axis Ax. As a result, the plurality of magnetic disks 13, the plurality of spacers 14, and the clamp 34 are also rotated around the rotation axis Ax.

When the rigidity of the clamp 34 is low, force through which the plurality of screws 35 fix the clamp 34 to the hub 32 may deform the clamp 34. In addition, the force through which the plurality of screws 35 fix the clamp 34 to the hub 32 may be unevenly transmitted to the plurality of magnetic disks 13. In this case, the plurality of rotating magnetic disks 13 may undulate (bend or warp).

When the magnetic disk 13 undulates, the flat surfaces 13a and 13b of the magnetic disk 13 are displaced in the first direction D1 or the second direction D2 with respect to the housing 11. Therefore, a distance between the slider 84 and the flat surface 13a or the flat surface 13b of the magnetic disk 13 becomes unstable, and a loss occurs in reading and writing of information by the slider 84. The HDD 10 according to the present embodiment includes ten or more (for example, eleven) magnetic disks 13. Therefore, each of the plurality of magnetic disks 13 becomes thin and is easily displaced. However, the clamp 34 of the present embodiment can improve rigidity and reduce undulation of the magnetic disk 13.

For example, as illustrated in FIG. 3, the outer circumferential surface 51c of the clamp tube 51 can be expanded until the diameter of the outer circumferential surface 51c becomes substantially the same as the diameter of the inner circumferential surface 13c of the magnetic disk 13. Since the diameter of the outer circumferential surface 51c is expanded, the rigidity of the clamp tube 51 is improved.

Furthermore, the retaining wall 52 is designed to, for example, hold a predetermined position of the magnetic disk 13. The retaining wall 52 extends from the outer circumferential surface 51c to the predetermined position. When the diameter of the outer circumferential surface 51c is expanded as in the present embodiment, a distance between the outer circumferential surface 51c and the predetermined position of the magnetic disk 13 becomes small. That is, the length of the retaining wall 52 in the radial direction becomes shortened. Therefore, the rigidity of the retaining wall 52 is improved.

Since the rigidity of the clamp 34 is improved as described above, the clamp 34 is less likely to be deformed even when fixed to the hub 32 by the plurality of screws 35. In addition, the force of the plurality of screws 35 to fix the clamp 34 to the hub 32 is more uniformly transmitted to the plurality of magnetic disks 13. Therefore, the plurality of rotating magnetic disks 13 are less likely to undulate.

Before the clamp 34 is attached to the hub 32, the uppermost magnetic disk 13U and the uppermost spacer 14U are not supported by the hub 32. However, the uppermost magnetic disk 13U and the uppermost spacer 14U can be positioned with respect to hub 32 by, for example, a cylindrical jig. Therefore, the uppermost magnetic disk 13U and the uppermost spacer 14U can be prevented from falling off from the spindle motor 12.

In the first embodiment described above, the HDD 10 includes the housing 11, the spindle motor 12, the plurality of magnetic disks 13, and the plurality of spacers 14. The spindle motor 12 includes the hub 32 and the clamp 34. The hub 32 is attached to the housing 11 inside the housing 11 and is rotatable around the rotation axis Ax with respect to the housing 11. The clamp 34 is attached to the hub 32. The plurality of magnetic disks 13 are attached to the spindle motor 12 while aligned with each other along the rotation axis Ax. The plurality of spacers 14 are attached to the spindle motor 12 and each of the spacers 14 is located between two adjacent magnetic disks 13 among the plurality of magnetic disks 13. Each of the plurality of magnetic disks 13 has the inner circumferential surface 13c oriented toward the rotation axis Ax. The plurality of spacers 14 each have the inner circumferential surface 14c oriented toward the rotation axis Ax. The hub 32 has the support wall 42 and the outer circumferential surface 41c. The support wall 42 supports the plurality of magnetic disks 13 and the plurality of spacers 14. The outer circumferential surface 41c extends from the support wall 42 in the first direction D1 along the rotation axis Ax to support at least one of the inner circumferential surfaces 13c of the plurality of magnetic disks 13 and at least one of the inner circumferential surfaces 14c of the plurality of spacers 14. The clamp 34 has the outer circumferential surface 51c and the retaining wall 52 to hold the plurality of magnetic disks 13 and the plurality of spacers 14 in-between the support wall 42 and the retaining wall 52. The outer circumferential surface 51c supports at least one of the outer circumferential surfaces 51c of the plurality of spacers 14. The retaining wall 52 protrudes from the outer circumferential surface 51c. In the first direction D1, the upper end 41e of the outer circumferential surface 41c is located closer to the support wall 42 than the upper end 14e of one of the inner circumferential surfaces 14c of the plurality of spacers 14, the one closest to the retaining wall 52.

In the case of using the outer circumferential surface 41c of the hub 32 to support the inner circumferential surfaces 13c of all the magnetic disks 13 and the inner circumferential surfaces 14c of all the spacers 14, for example, a part of the clamp 34 is to be fitted in a recess in the hub 32. In this case, the outer circumferential surface of the clamp 34 fitting in the recess is situated more radially inward than the outer circumferential surface 41c of the hub 32. That is, the diameter of the outer circumferential surface of the clamp 34 decreases. It is also conceivable that without the recess formed in the hub 32, the clamp 34 is placed at the end of the hub 32 in the first direction D1. In this case, the clamp 34 will have a thinner thickness in the direction along the rotation axis Ax. Meanwhile, in the HDD 10 according to the present embodiment, the outer circumferential surface 51c of the clamp 34 has substantially the same diameter as that of the inner circumferential surfaces 14c in order to support the inner circumferential surfaces 14c of the spacers 14. Thus, the outer circumferential surface 51c of the clamp 34 is expanded to substantially the same diameter as the inner circumferential surfaces 14c of the spacers 14. This can lead to improving the rigidity of the clamp 34 in the HDD 10. For example, at the time of attaching the clamp 34 to the hub 32 with the screws 35, the clamp 34 having higher rigidity can more uniformly transmit the force of the screws 35 to the magnetic disks 13, and is less likely to be bent by the screws 35 and the magnetic disks 13. As such, the HDD 10 can avoid undulation of the rotating magnetic disks 13 held by the clamp 34.

The clamp 34 has the inner circumferential surface 51d oriented toward the rotation axis Ax. The hub 32 has the fitting surface 43a that supports the inner circumferential surface 51d. As a result, the fitting surface 43a of the hub 32 can restrict the radial movement of the clamp 34 relative to the hub 32. Namely, the hub 32 can appropriately position the clamp 34.

The upper end 41e of the outer circumferential surface 41c in the first direction Dl is located closer to the support wall 42 than the uppermost spacer 14U closest to the retaining wall 52 among the plurality of spacers 14. That is, in the direction along the rotation axis Ax, the outer circumferential surface 51c of the clamp 34 is equal to or larger in length (thickness) than the inner circumferential surface 14c of the spacer 14. In this manner, the clamp 34 can be improved in rigidity in the HDD 10.

The outer circumferential surface 51c supports at least one of the inner circumferential surfaces 13c of the plurality of magnetic disks 13. As a result, the outer circumferential surface 51c of the clamp 34 has substantially the same diameter as that of the inner circumferential surface 13c in order to support the inner circumferential surface 13c of the magnetic disk 13. That is, the outer circumferential surface 51c of the clamp 34 is expanded to substantially the same diameter as the inner circumferential surface 13c of the magnetic disk 13. In this manner, the clamp 34 can be improved in rigidity in the HDD 10.

The upper end 41e of the outer circumferential surface 41c in the first direction D1 is located closer to the support wall 42 than the uppermost magnetic disk 13U closest to the retaining wall 52 among the plurality of magnetic disks 13. Thus, in the direction along the rotation axis Ax, the outer circumferential surface 51c of the clamp 34 is larger in length (thickness) than the inner circumferential surface 13c of the magnetic disk 13. This can improve the rigidity of the clamp 34 in the HDD 10.

Among the plurality of spacers 14, the inner circumferential surface 14c of the uppermost spacer 14U closest to the retaining wall 52 is supported by the outer circumferential surface 51c of the clamp 34 while the inner circumferential surfaces 14c of the remaining lower spacers 14L are supported by the outer circumferential surface 41c of the hub 32. This arrangement allows the outer circumferential surface 41c to appropriately position the plurality of spacers 14 except for the uppermost spacer 14U before attaching the clamp 34 to the hub 32. As such, the HDD 10 can be easily assembled.

Among the plurality of magnetic disks 13, the inner circumferential surface 13c of the uppermost magnetic disk 13U closest to the retaining wall 52 is supported by the outer circumferential surface 51c of the clamp 34 while the inner circumferential surfaces 13c of the remaining lower magnetic disks 13L are supported by the outer circumferential surface 41c of the hub 32. This makes it possible for the outer circumferential surface 41c to appropriately position the plurality of magnetic disks 13 except for the uppermost magnetic disk 13U before attaching the clamp 34 to the hub 32. This can also facilitate the assembly of the HDD 10 as compared with an HDD 10 having the uppermost magnetic disk 13U as well as the other magnetic disks 13 and at least one spacer 14 not appropriately positioned.

### Second Embodiment

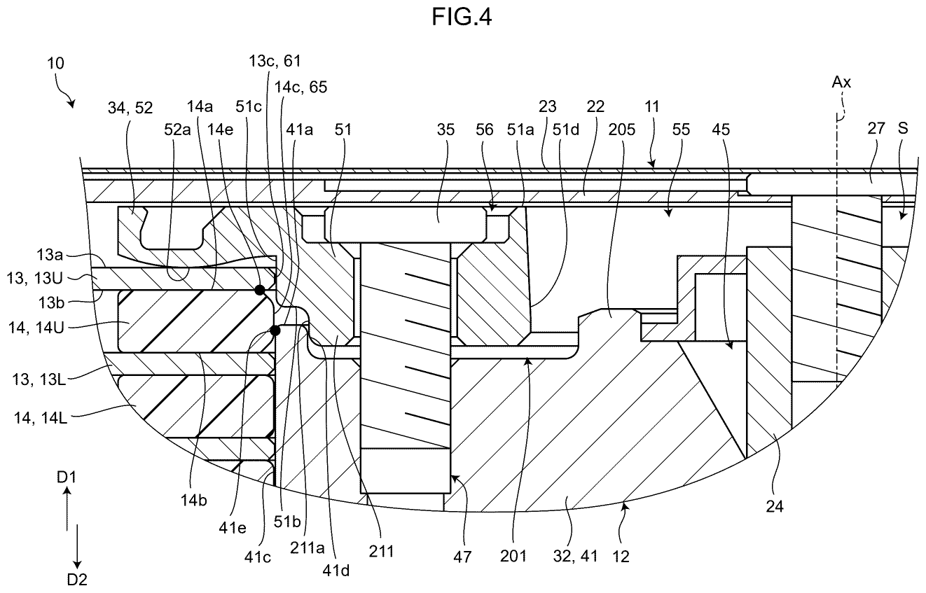

Hereinafter, a second embodiment will be described with reference to FIG. 4. It is noted that, in the following description of the plurality of embodiments, components having functions similar to those of components already described are denoted by the same reference numerals as those of the components already described, and the description thereof may be omitted. In addition, the plurality of components denoted by the same reference numerals do not necessarily have all the functions and properties in common, and may have different functions and properties according to each embodiment.

FIG. 4 is an exemplary cross-sectional view illustrating a portion in the vicinity of the clamp 34 of the HDD 10 according to the second embodiment. As illustrated in FIG. 4, a recess 201 is formed in the end surface 41a of the hub tube 41 of the second embodiment. The recess 201 is recessed from the end surface 41a in the second direction D2. The recess 201 is, for example, a groove extending in the circumferential direction. It is noted that the recess 201 is not limited to this example.

The hub tube 41 of the second embodiment further includes an inner circumferential surface 41d. The inner circumferential surface 41d is an example of a fourth inner circumferential surface. The inner circumferential surface 41d is opposite the outer circumferential surface 41c. The inner circumferential surface 41d has a cylindrical shape extending along the rotation axis Ax and defines the recess 201. The inner circumferential surface 41d is oriented inwards in the radial direction. That is, the inner circumferential surface 41d is oriented toward the rotation axis Ax. It is noted that the inner circumferential surface 41d may be oriented, for example, in an oblique direction. The diameter of the inner circumferential surface 41 d is, for example, about 24.0 mm. It is noted that the diameter of the inner circumferential surface 41d is not limited to this example.

The hub 32 of the second embodiment has a protrusion 205 instead of the protrusion 43. The protrusion 205 protrudes from the hub tube 41 in the first direction D1 at a position closer to a rotation axis Ax than the recess 201.

The clamp 34 of the second embodiment further includes a projection 211. The projection 211 protrudes in the second direction D2 from the end surface 51b of the clamp tube 51. The projection 211 has, for example, an annular shape extending in the circumferential direction. It is noted that the projection 211 is not limited to this example.

The projection 211 has an outer circumferential surface 211a. The outer circumferential surface 211a is an example of a fourth outer circumferential surface. The outer circumferential surface 211a is a substantially cylindrical curved surface extending along the rotation axis Ax. The outer circumferential surface 51c is oriented outwards in the radial direction. The diameter of the outer circumferential surface 211a is, for example, approximately 23.5 mm. It is noted that the diameter of the outer circumferential surface 211a is not limited to this example.

The diameter of the outer circumferential surface 211a of the projection 211 is smaller than the diameter of the outer circumferential surface 51c of the clamp tube 51. The diameter of the outer circumferential surface 211a of the projection 211 is smaller than the diameter of the inner circumferential surface 41d of the hub tube 41.

The projection 211 is fitted into the recess 201 of the hub tube 41. The outer circumferential surface 211a of the projection 211 is at least partially in contact with the inner circumferential surface 41d of the hub tube 41. As a result, the outer circumferential surface 211a supports the inner circumferential surface 41d, and restricts the radial movement of the clamp 34 relative to the hub 32. On the other hand, the protrusion 205 of the hub 32 is separated from the inner circumferential surface 51d of the clamp tube 51.

In the second embodiment, the outer circumferential surface 41c of the hub tube 41 contacts not only the inner circumferential surface 14c of the lower spacer 14L but also the inner circumferential surface 14c of the uppermost spacer 14U. That is, the inner circumferential surface 14c of the uppermost spacer 14U supports the outer circumferential surface 41c of the hub tube 41.

The inner circumferential surface 14c of the uppermost spacer 14U faces the outer circumferential surface 51c of the clamp tube 51. The inner circumferential surface 14c of the uppermost spacer 14U can come into contact with the outer circumferential surface 51c of the clamp tube 51. That is, the inner circumferential surface 14c of the uppermost spacer 14U can support the outer circumferential surface 51c of the clamp tube 51. It is noted that, in the second embodiment, the inner circumferential surface 14c of the uppermost spacer 14U may be spaced from the outer circumferential surface 51c of the clamp tube 51.

In the HDD 10 of the second embodiment described above, the hub 32 has the inner circumferential surface 41d oriented toward the rotation axis Ax. The clamp 34 has the outer circumferential surface 211a that supports the inner circumferential surface 41d. As a result, the inner circumferential surface 41d of the hub 32 restricts the radial movement of the clamp 34 relative to the hub 32. One of the plurality of spacers 14 has the inner circumferential surface 14c supporting the outer circumferential surface 41c of the hub 32 and the outer circumferential surface 51c of the clamp 34. Thereby, the one spacer 14 restricts the radial movement of the clamp 34 relative to the hub 32. In this manner, the hub 32 and the spacer 14 can appropriately position the clamp 34.

### Third Embodiment

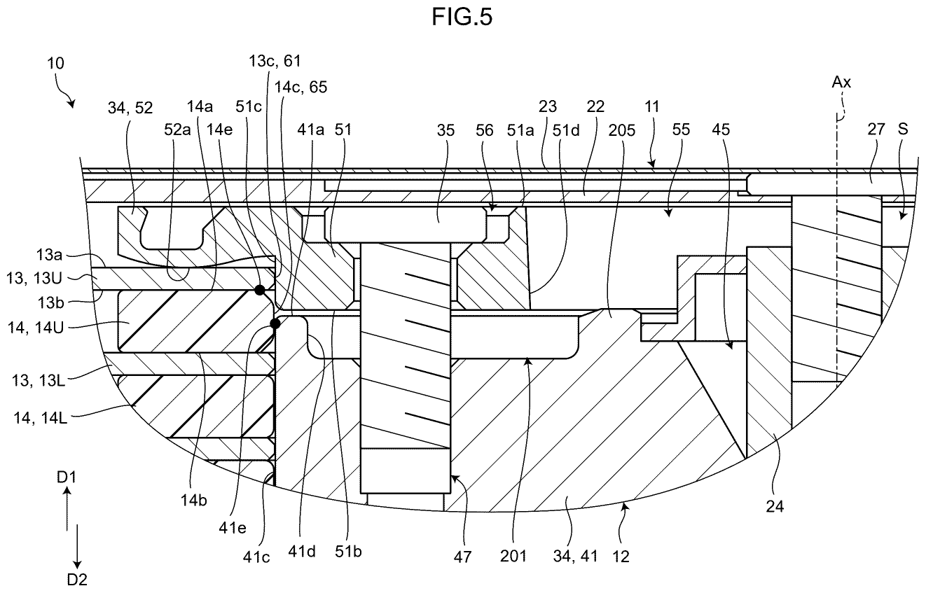

Hereinafter, a third embodiment will be described with reference to FIG. 5. FIG. 5 is an exemplary cross-sectional view illustrating a portion in the vicinity of the clamp 34 of the HDD 10 according to the third embodiment. As illustrated in FIG. 5, the HDD 10 according to the third embodiment is different from the HDD 10 according to the second embodiment in that the clamp 34 does not have the projection 211.

Without the projection 211, the clamp 34 can be more easily manufactured. Further, in the third embodiment, one of the plurality of spacers 14 has the inner circumferential surface 14c supporting the outer circumferential surface 41c of the hub 32 and the outer circumferential surface 51c of the clamp 34. As a result, the one spacer 14 restricts the radial movement of the clamp 34 relative to the hub 32. In this manner, the hub 32 and the spacer 14 can appropriately position the clamp 34.

### Fourth Embodiment

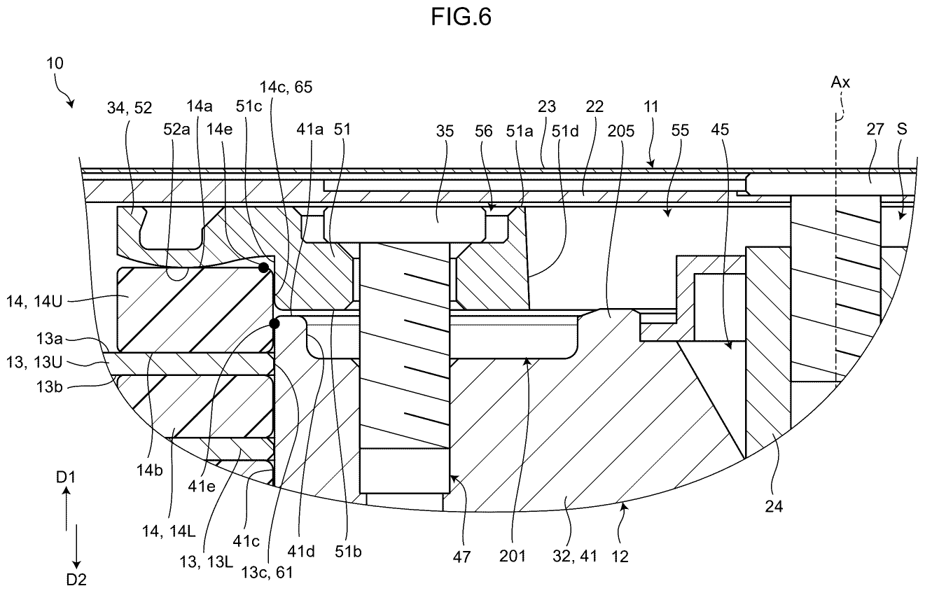

Hereinafter, a fourth embodiment will be described with reference to FIG. 6. FIG. 6 is an exemplary cross-sectional view illustrating a portion in the vicinity of the clamp 34 of the HDD 10 according to the fourth embodiment. As illustrated in FIG. 6, the HDD 10 of the fourth embodiment is different from that of the third embodiment in that the uppermost spacer 14U is located between the uppermost magnetic disk 13U and the retaining wall 52. That is, the uppermost spacer 14U is located between the clamp 34 and one of the plurality of magnetic disks 13, and is closer to the retaining wall 52 than the plurality of magnetic disks 13. The abutting surface 52a of the retaining wall 52 is in contact with the flat surface 14a of the uppermost spacer 14U.

In the direction along rotation axis Ax, a distance (thickness of the uppermost spacer 14U) between the flat surface 14a and the flat surface 14b of the uppermost spacer 14U is larger than a distance (thickness of a lower spacer 14L) between the flat surface 14a and the flat surface 14b of the lower spacer 14L. It is noted that the thickness of the uppermost spacer 14U and the thickness of the lower spacer 14L are not limited to this example.

The upper end 41e of the outer circumferential surface 41c of the hub tube 41 is closer to the support wall 42 than the upper end 14e of the inner circumferential surface 14c of the uppermost spacer 14U. The outer circumferential surface 41c of the hub tube 41 contacts not only the inner circumferential surfaces 14c of the lower spacers 14L but also the inner circumferential surface 14c of the uppermost spacer 14U. That is, the inner circumferential surface 14c of the uppermost spacer 14U supports the outer circumferential surface 41c of the hub tube 41.

Further, the inner circumferential surface 14c of the uppermost spacer 14U contacts the outer circumferential surface 51c of the clamp tube 51. That is, the inner circumferential surface 14c of the uppermost spacer 14U supports the outer circumferential surface 51c of the clamp tube 51.

The outer circumferential surface 41c of the hub tube 41 contacts not only the inner circumferential surface 13c of the lower magnetic disk 13L but also the inner circumferential surface 13c of the uppermost magnetic disk 13U. That is, the outer circumferential surface 41c of the hub tube 41 supports all the inner circumferential surfaces 13c of the plurality of magnetic disks 13.

In the HDD 10 of the fourth embodiment described above, among the plurality of spacers 14, the uppermost spacer 14U closest to the retaining wall 52 is located closer to the retaining wall 52 than the plurality of magnetic disks 13. As a result, in designing the HDD 10, it is made easier to dispose the uppermost magnetic disk 13U, closest to the retaining wall 52, of the plurality of magnetic disks 13 at a desired position with respect to the hub 32. For example, it is made possible to arrange the plurality of magnetic disks 13 in the HDD 10 such that the outer circumferential surface 41c of the hub 32 supports the inner circumferential surfaces 13c of all of the magnetic disks 13.

The outer circumferential surface 41c supports all of the inner circumferential surfaces 13c of the plurality of magnetic disks 13. Thereby, the outer circumferential surface 41c can appropriately position all the magnetic disks 13 before attaching the clamp 34 to the hub 32. This can thus facilitate the assembly of the HDD 10.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms modifications as would fall within the scope and spirit of the inventions.

1. A magnetic disk device comprising:
a housing;
a motor including
a hub being attached to the housing inside the housing so as to be rotatable around a rotation axis relative to the housing, and
a clamp being attached to the hub;
a plurality of magnetic disks attached to the motor while aligned with each other along the rotation axis; and
a plurality of spacers attached to the motor, each of which is located between two adjacent magnetic disks among the plurality of magnetic disks or between the clamp and one of the plurality of magnetic disks,
wherein
each of the plurality of magnetic disks has a first inner circumferential surface oriented toward the rotation axis,
each of the plurality of spacers has a second inner circumferential surface oriented toward the rotation axis,
the hub has
a support wall supporting a stack of the plurality of magnetic disks and the plurality of spacers, and
a first outer circumferential surface extending from the support wall in an extension direction along the rotation axis and being in contact with the first inner circumferential surface of at least one of the plurality of magnetic disks and with the second inner circumferential surface of at least one of the plurality of spacers,
the clamp has
a second outer circumferential surface being in contact with the second inner circumferential surface of at least one of the plurality of spacers, and
a retaining wall protruding from the second outer circumferential surface, and
the clamp holds the stack of the plurality of magnetic disks and the plurality of spacers in-between the support wall and the retaining wall.

2. The magnetic disk device according to claim 1, wherein
the clamp has a third inner circumferential surface oriented toward the rotation axis, and
the hub has a third outer circumferential surface that is in contact with the third inner circumferential surface.

3. The magnetic disk device according to claim 1, wherein
the hub has a fourth inner circumferential surface oriented toward the rotation axis, and
the clamp has a fourth outer circumferential surface that is in contact with the fourth inner circumferential surface.

4. The magnetic disk device according to claim 1, wherein
the second inner circumferential surface of one of the plurality of spacers is in contact with the first outer circumferential surface and the second outer circumferential surface.

5. The magnetic disk device according to claim 1, wherein
in the extension direction the first outer circumferential surface has an end closer to the support wall than one of the plurality of spacers, the one closest to the retaining wall.

6. The magnetic disk device according to claim 1, wherein
the second outer circumferential surface is in contact with the first inner circumferential surface of at least one of the plurality of magnetic disks.

7. The magnetic disk device according to claim 6, wherein
in the extension direction the first outer circumferential surface has an end closer to the support wall than one of the plurality of magnetic disks, the one closest to the retaining wall.

8. The magnetic disk device according to claim 1, wherein
one of the plurality of spacers, the one closest to the retaining wall, is located closer to the retaining wall than the plurality of magnetic disks.

9. The magnetic disk device according to claim 8, wherein
the first outer circumferential surface is in contact with all of the first inner circumferential surfaces of the plurality of magnetic disks.

10. The magnetic disk device according to claim 1, wherein
the second inner circumferential surface of one of the plurality of spacers, the one closest to the retaining wall, is in contact with the second outer circumferential surface, and
the second inner circumferential surfaces of the rest of the plurality of spacers are in contact with the first outer circumferential surface.

11. The magnetic disk device according to claim 1, wherein
the first inner circumferential surface of one of the plurality of magnetic disks, the one closest to the retaining wall, is in contact with the second outer circumferential surface, and
the first inner circumferential surfaces of the rest of the plurality of magnetic disks are in contact with the first outer circumferential surface.
